(19) United States
(12) Patent Application Publication
(10) Pub. No.: US 2004/0220500 A1
(43) Pub. Date: Nov. 4, 2004

(54) Apparatus for cervical region diagnostics and training

(76) Inventor: Keid Dahl, Silkeborg (DK)

Correspondence Address: NIXON PEABODY, LLP, 401 9TH STREET, NW, SUITE 900, WASHINGTON, DC, 20004-2128, US

(21) Appl. No.: 10/477,177

(22) PCT Filed: May 10, 2002
(86) PCT No.: PCT/DK02/00309

(30) Foreign Application Priority Data
May 10, 2001 (DK) PA 2001 00742

(51) Int. Cl. A61H 1/02

(52) U.S. Cl. 601/5; 601/25; 601/26

(57) ABSTRACT

Apparatus for cervical region diagnostics and training. The apparatus comprises a head unit for receiving the head of a patient, wherein the head unit is connected to a support device with a flexible connection such that the head unit is rotatable and translatable in all three dimensions to provide complete freedom of movement for the patient's head.

### FIELD OF THE INVENTION

The present invention relates to an apparatus for cervical region diagnostics and training, in particular for evaluating segmentary mobility of the cervical region of a patient and for evaluating the capability of the patient to co-ordinate the muscles in the neck region.

### BACKGROUND OF THE INVENTION

In order to promote the recovery from injuries in the cervical region, for example after vehicle or sports accidents, cervical training methods of various kinds have been devised. One of the more recent innovations is a cervical muscle evaluation apparatus as disclosed in U.S. Pat. No. 5,997,440. This apparatus comprises a head station for receiving a patient's head, the motion of which can be controlled and trained according to certain degrees of freedom given by the construction of the apparatus. As far as the bending of the cervical region is concerned, this apparatus only allows bending about one horizontal axis. The apparatus is constructed such that bending around a different horizontal axis requires reseating of the patient in the apparatus after a rotation of the seat through 90°.

In U.S. Pat. No. 4,768,779 by Oehmann and Nelson, U.S. Pat. No. 4,893,808 by McIntire et al. and U.S. Pat. No. 5,336,138 by ArMawat, exercise machines are disclosed, where the head can be moved in bending directions but not translational.

However, it would be desirable, if the possibility would exist to evaluate and train the cervical region of a patient in all motional directions. Also, it would be desirable to have an apparatus for evaluating the functioning of the cervical region, for example in connection with the special kind of movement where the forehead is moved along a circular path in a horizontal plane, eventually combined a rotational movement of the head about an axis.

It is of high concern in modem neck therapy to measure segmentary mobility/immobility and to train the segmentary mobility in order to increase the mobility of the neck in those regions that actually have an unsatisfactory mobility. Also highly relevant is the measuring of the ability of the patient to co-ordinate muscles in the neck region.

### SUMMARY OF THE INVENTION

Thus, it is the purpose of the invention to provide an improved diagnosis and training device. Especially, it is the purpose of the invention to provide an apparatus for evaluating segmentary mobility and for evaluating the ability to co-ordinate muscles in the neck region.

This purpose is achieved with an apparatus for evaluating segmentary immobility of the cervical region of a patient, the apparatus comprising

a head unit for receiving the head of the patient, wherein the head unit is connected to a support device,

a flexible, multi-axial rotational connection between the head unit and the device such that the head unit is able to follow the head of the patient with arbitrary rotational movement,

at least one movement sensor to register the movement of the head unit relatively to the support device, and

a monitoring system functionally connected to the at least one movement sensor, wherein the monitoring system is configured to monitor and store parameters, for example position, speed, and/or direction, of the movement of the head in the head unit,

wherein the apparatus is characterised over prior art by also comprising

a flexible, multi-axial translational connection between the head unit and the support device such that the head unit is able to follow the head of the patient during both arbitrary lateral and rotational head motion with arbitrary head motion amplitude, and

an analysing system functionally connected to the monitoring system for analysing the segmentary mobility and the ability to co-ordinate muscles in the cervical region of the patient.

By measuring the segmentary mobility of the neck with an apparatus according to the invention, the therapist is able to determine the mobility of each segment of the spinal column in the neck region in order to reveal eventual stiffness or other problems relating to the bending of the neck, for example pain regions related to the bending of certain segments. Therefore, with the apparatus according to the invention, it is possible to measure and show—with the precision of a single segment in the neck—whether a therapeutic effort has been successful.

Investigating segmentary mobility/immobility reveals the actual conditions in the neck of a patient. This knowledge is highly relevant for an efficient, result oriented therapeutic effort, for example directed towards the functioning of a single segment. Knowing the state of certain or all segments minimises the risk of wrong therapeutic treatment.

In despite of the versatility of the apparatus according to the invention, it is affordable for even small therapeutic entities such that widespread use of the apparatus is possible and may led to new standards in neck therapy. For example, x-rays of the neck of a patient under different neck bending may be omitted, thus reducing the x-ray exposure to patients, reduce the overall costs and result in faster and more safe evaluation of the neck region. Because of its many motional degrees of freedom, the apparatus according to the invention is highly applicable to scientific investigations on a broad level. For example, the apparatus may be used for investigation of certain dysfunction tendencies in certain groups of the population. With an apparatus according to the invention, it is possible to achieve precise documentation for whether a certain kind of therapy leads to improvements. Therapies may therefore in future not be based alone on the judgement of the therapist or the training person but may be based on measurable parameters that have the potential of international standards in neck therapy.

The apparatus according to the invention is intended for diagnosis and training of the cervical region of a person, for simplicity in the following called a patient, though this person may use the apparatus on his/her own without being supervised as a patient by medical personnel.

The apparatus comprises at least one movement sensor to register the movement of the head unit relatively to the support device. It is of vital interest for evaluation during the recovery period that the mobility of the cervical region, especially the segmentary mobility and ability to co-ordinate the neck muscles, can be measured. For this reason, sensors may be installed at suitable locations in order that these measurements may be performed. Such sensors may be mechanically driven sensors, for example connected to wires that are pulled during movements, but may as well as known by the skilled man be based on evaluation of pressure signals, electrical signals, light signals or radio signals.

In practice, the apparatus according to the invention may comprise a support device which may be mounted rigidly to a wall, the floor or the ceiling. In order to follow the movement of the patient more freely, the support device may be mounted with rollers to the wall, floor or ceiling, or the support device may be free standing on the floor with rollers for transportation together with the movement of the patient or just for transportation of the apparatus. In a light weight variant, the support device may be carried by the person itself, for example in connection with a harness resting on shoulders and hips of the patient. In order to provide a light weight variant of the apparatus, robot technology may successfully be applied, where the connection between the support device and the head unit comprises a multi-axial robot arm. Generally, the term support device has to be understood in a wide sense. For example, the support device may be comprised by a wall to which the flexible, multi-axial rotational and translational connection is mounted.

The head unit is connected to the support device by a flexible connection. The term flexible has to be understood in a broad sense meaning that the connection is configured such that the head unit can be moved by general means relative to the support device. During diagnosis and training, the patient places the head in the head unit of the apparatus and exerts force on the head unit. The head unit can be moved laterally and rotationally with respect to three orthogonal axes such that any arbitrary movement of the head unit is possible with maximum amplitude, for example a movement where the forehead travels along a circular path in a horizontal plane. With the apparatus according to the invention, all muscles in the cervical region can be examined and trained.

In a further embodiment of the invention, the apparatus comprises at least one force sensor for measuring the force exerted on the head unit. As the patient moves the head, the applied force is measured during the motion of the head unit. The force sensor is preferably functionally connected to the monitoring system to monitor and store parameters of the force exerted on the head unit.

In a further embodiment of the invention, the at least one force sensor and the at least one force element are functionally connected and configured in co-operation to counteract the gravity of the head unit such that said head unit appears weightless. This is important for the patient in order to feel comfortable. In addition, it is important for measuring properly the motion and forces of the patient's head without having to take into regard eventual inappropriate forces that the patient has to concentrate on for holding the head unit in place. Thus, also persons with very weak neck muscles or weak neck stability may use the apparatus.

In general, the principle of a weightless head unit is known, for example from the aforementioned U.S. Pat. No. 4,893,808 by McIntire et al. The disclosure in this patent uses counterweights in order to give a feeling of a weightless head unit. However, this only gives a weightless feeling as long as the disclosed apparatus is not moved. The counterweights result in a high inertia of the head unit which requires high force by the patient in order to accelerate or decelerate the head unit. This is not only unpleasant for the patient but even dangerous in case that the neck of the patient is injured or weak. According to the invention, the weightless appearance of the head unit is accomplished by a close interplay between the force sensor and the force elements, for example by having a computer calculating the necessary forces in dependence of the position and the velocity of the head unit. Having measured or programmed the weight of the head unit without the head of the patient, the force exerted on the head unit by the at least one force element is exactly balanced with the weight and the inertia such that the patient experiences the head unit as weightless in the static state as well as in the moving state. In order to accelerate the head in the head unit, the patient only has to exert the force for accelerating the head itself but practically not the head unit. The head unit will freely follow the motion of the head of the patient.

In order to train the muscles in the neck and in order to evaluate the functioning of the neck when using force, force elements may counteract the movement of the head. The force from the force elements may be applied to the head through the head unit according to different principles. For example, the force may be constant in magnitude along a path during the movement of the head unit. In a first alternative, the force may be constant in magnitude but independent of the direction of the movement of the head unit. In a second alternative, the force may be decreasing or increasing along a path during the movement of the head. In a third alternative, the force may be dependent on the speed of the movement of the head unit, for example imitating movements under water. Furthermore, the force may be chosen according to any other user freely determined scheme.

Alternatively, the force may be measured without motion of the head unit, or only with a small preadjustable movement of the head unit. This is a different treatment, where the patient counteracts a force and tries to avoid any movement of the head.

As the apparatus comprises a monitoring system functionally connected to the movement sensor and optionally the force sensor, training periods can be monitored for immediate or later evaluation. The monitoring system is configured to monitor and store parameters of the movement of the head unit, for example position, speed and direction, and/or of the force exerted on said head unit. Preferably, the monitoring system comprises a computer system with display unit for processing and displaying the parameters and related data, preferably in graphical form. This feature eases the evaluation procedure of the diagnosis and the training. From the first to the last training periods, parameters are recorded and can be evaluated to observe changes in the state of the cervical region of the patient. For the evaluation, data are displayed, for example in tabular form or in graphical form. Graphical form is preferred, as this eases the evaluation and minimises malinterpretation.

Other parameters to be displayed may be the actual position of the head unit, the speed of the head unit, the velocity (speed and direction of movement) of the head unit, the acceleration, the direction of acceleration, the natural equilibrium position as felt by the patient, the natural equilibrium position as expected and indicated by a therapist, maximum translational, bending, and rotational amplitudes for the head in the head unit, head unit positions where the patient indicates pain, or forces exerted on the head unit. Also, the movement of the head unit may be displayed in an area diagram, where the form of the displayed area reflects the extension of the possible movements of the patient's head. An increase of this area thus reflects a greater freedom of movement indicating an improvement of the health state of the cervical region.

In a further embodiment of the invention, the apparatus comprises a monitor visible by the patient, the monitor illustrating an interactive user interface with an indicator on a background image, the indicator being functionally connected to the movement sensor and being configured to move on the background image in relation to the movement of the head unit. This embodiment helps the patient to follow the motion of the head unit during a training session, which is helpful for better control and evaluation.

Advantageously, the background image shows a path system motivating the patient to move the head unit such that the indicator follows the paths in the path system. This embodiment is extremely useful for patients, where the patient tend to concentrate on pain in the neck more than on the movement. By moving the head with the head unit along the predetermined paths, the patient experiences the training or evaluation session as a kind of computer play which draws the concentration away from the pain experience and directs it towards the accomplishment of an eventually larger movement than originally allowed by the patient. Preferably, the path system is specially designed according to the cervical condition and/or cervical training of the patient. Thus, the path system may be changed after each training session in order to motivate the patient to work for increased ability to move the head.

The apparatus according to the invention may also be configured to be applicable for rhythmic stabilisation. This kind of training may be performed as the so-called active rhythmic stabilisation or passive stabilisation.

The passive rhythmic stabilisation is a special training, wherein the head unit is stationary at a prefixed position until the force exerted on the head unit by the patient is higher than a pre-set value, after which the head unit is configured to follow, preferably reluctantly, the direction of the exerted force. The prefixed position may for example be the natural equilibrium position as felt by the patient or the natural equilibrium position as expected and indicated by a therapist. This training method is especially useful for giving the patient the feeling for force without overloading the cervical muscles, as the head unit as an indicator may stop resisting the force of the head on the head unit at a predetermined force level. In principle, the head unit may stop the resistance against the force on the head unit instantaneously at a predetermined force level. However, this would imply that after having exceeded a certain force, the patient would risk to have his head moved fast and with a rather large amplitude before the patient has reduced the force again until below a certain level, where the head unit returns to the original position. By having the head unit to follow the direction of the force reluctantly, injuries are prevented to a higher degree for those patients for which motions with large amplitude are harmful.

In active rhythmic stabilisation, the head unit exerts force on the head of the patient, who tries to resist the force without moving the head. The force starts at a small level in a certain direction and increases until a predetermined level, after which the force is reduced and build up in a new direction. Thus, the head of the patient is trained in different directions without having to move the head. If the strength of the neck muscles in a certain direction is not high enough and the patient starts moving the head, the force is instantaneously reduced for giving the patient the possibility to return to the original position.

The advantage is a training and evaluation of the co-ordination of the neck muscles because the interaction of muscles are trained. For example, if a segment has been injured, joint receptors, so called mechanoreceptors, may have been damaged such that the patient has difficulties in having a precise feeling for the orientation of his head, especially when eyes are closed. The training of the mechanoreceptors according to prior art is difficult, because bending of the injured segment may be painful and harmful. Rhythmic stabilisation, offers the possibility to find a position of the neck where it is possible to make exercises without moving the injured segment. This leads to an earlier pain reduction or pain removal in the recovery period. Also, training may be started earlier in the recovery period for improving the circulation in the area with dysfunction and for stimulating, improving and regaining the normal function of the mechanoreceptors in order to achieve a fast and optimised recovery of the neck region.

### SHORT DESCRIPTION OF THE DRAWINGS

The invention will be explained in more detail in the following with reference to the drawing, where

FIG. 1 shows an embodiment of the apparatus according to the invention,

FIG. 2 shows the apparatus with a patient,

FIG. 3 shows two variants of the apparatus,

FIG. 4 shows a client data menu,

FIG. 5 shows a function menu,

FIG. 6 shows an anamnese menu,

FIG. 7 shows a mobility menu,

FIG. 8 shows a program choice menu,

FIG. 9 shows a force menu,

FIG. 10 shows a power menu,

FIG. 11 shows a force curve adjustment menu,

FIG. 12 shows a comparison menu,

FIG. 13 shows a possible monitor lay-out with a path system to be followed by the patient

### DETAILED DESCRIPTION/PREFERRED EMBODIMENT

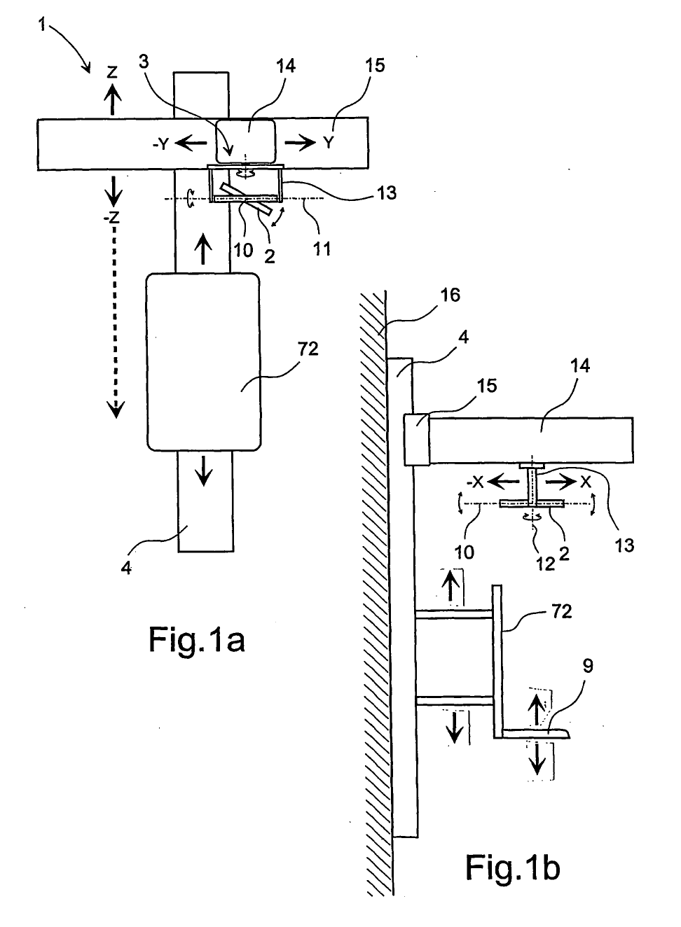

FIG. 1 shows the apparatus in one embodiment of the invention as seen from the front in FIG. 1a and as seen from the side in FIG. 1b. In this embodiment of the invention, a support seat 9 is height adjustable relative to the back-rest 72 which again is height adjustable relative to the support frame 4. The support frame in this embodiment is mounted to a wall element 16. When a patient is seated on the seat 9, the seat and the back-rest are mutually adjusted and the seat is height adjusted relative to the support frame 4 in order that an optimised seating position. Preferably, the back support 72 will be adjusted such that the upper end of the back support 72 is situated at the lowest neck segment. The height adjustment of the seat 9 and the back support 72 may be stored for each patient, such that the same adjustment is used each time a specific patient uses the apparatus 1.

Between the head unit 2 and the support frame 4, a flexible connection is provided, for multi-axial lateral and rotational movement of the head unit 2, such that the head unit 2 can follow any arbitrary motion of the head of the patient. The head unit 2 is mounted pivotably around a vertical axis 12, a first axis 10 and a second axis 11, which for the actually shown head unit position are both horizontal. It should be recognised that this principle is analogous to a gyro suspension and that the first axis 10 will not stay horizontal when the head unit 2 is rotated around the second axis 11. In addition to the three rotational axes 10, 11, 12, the head unit 2 can be translated along three orthogonal directions indicated as the X, Y and Z directions. Resulting in a so called floating suspension, this is achieved by a three part connection comprising a first part 13, allowing a translation in the X direction relative to the second part 14, which can be moved in the Y direction with respect to the third part 15, which again can be moved in the Z direction relative to the support frame 4. This way, the head unit 2 can be moved freely in all three dimensions with any arbitrary combination of translation and rotation.

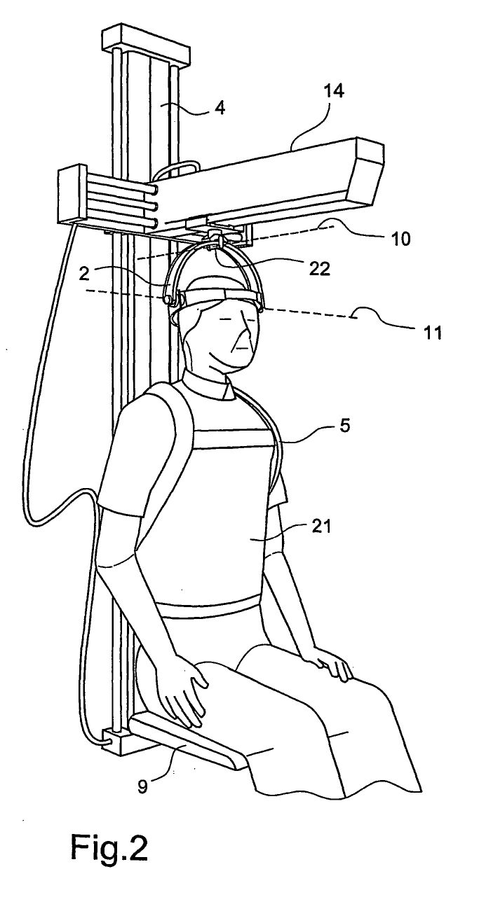

FIG. 2 shows the apparatus according to the invention with a patient 21 in a perspective view. The patient 21 is fixed in the apparatus 1 by a restraining belt 5 in order that the patient 21 is fixed with respect to the support frame 4 such that a correct data collection for the functioning of the neck can be assured. However, in order to illustrate that different practical solutions can be envisaged, the head unit 2 shown in FIG. 2 is slightly different from the head unit 2 in FIG. 1a and 1b in that the turning point 22 of the first axis 10 is above the head of the patient 21.

According to the invention, the force sensors and the force elements are functionally connected and configured in co-operation to counteract the gravity of the head unit 2 such that the head unit 2 appears weightless and also to counteract the inertia of the head unit 2 during movement such that the head unit 2 appears weightless during motion. The force sensors may measure the weight of the head unit 2 after which also corresponding inertia are calculated. Furthermore, eventual resistance in the moving parts are taken into account for the force elements such that the head unit 2 feels weightless not only in a static situation but also during motion of the head unit 2.

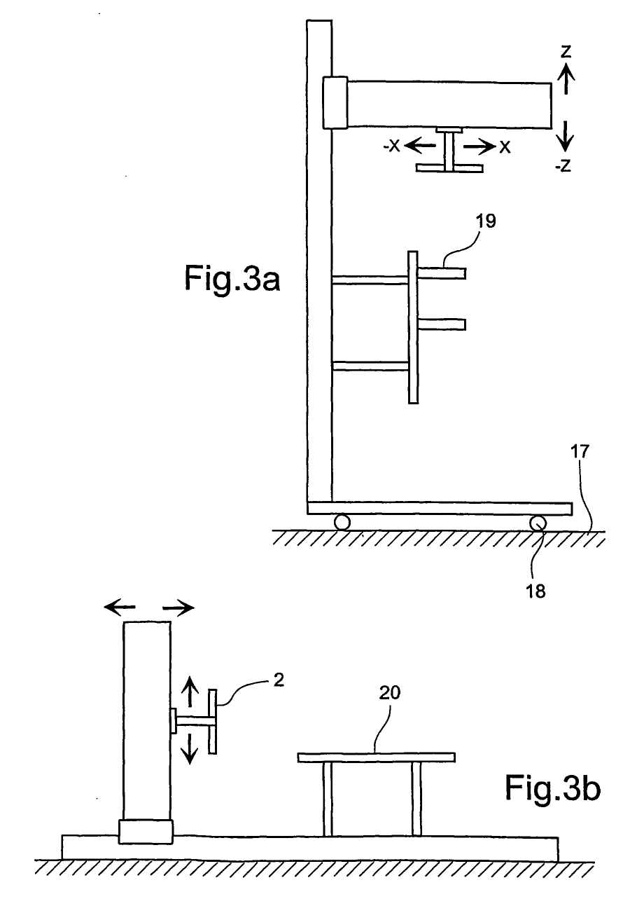

In FIG. 3, two variants of the apparatus 1 according to the invention are shown. In FIG. 3a, the apparatus 1 of the invention is free standing on the floor 17 with rollers 18 for transportation of the support frame 4 together with the movement of the patient, which is fixed to the support frame 4 by means of fasteners 19 or, alternatively a restraining belt as shown in FIG. 2. The lowest part 73 of the frame 4 with the rollers 18 is U-shaped in order that the patient may rest the feet on the ground.

In FIG. 3b, the apparatus 1 of the invention is arranged for patients that have to perform the training in a supine position. The patient will in this case lie on a platform 20 with the head resting in the head unit 2, which will be pre-loaded with a lifting force in order to support the head of the patient such that the patient experiences not only the head unit 2 as weightless but also experiences the head as weightless. This is one of the great advantages of the invention due to the programmable and computer controlled interplay between the force sensor and the force elements. The programming of the force elements (not shown) can be performed, for example, by a therapist. The programming may be simple by activating a calibration procedure after having placed the patient's head in the head unit 2. The force sensors may then measure the weight of the head together with the head unit 2. In addition, corresponding inertia are calculated. Furthermore, eventual resistance in the moving parts of the apparatus and eventual inertia of the moving parts are taken into account for the force elements such that the head in the head unit 2 feels weightless also during motion of the head.

The translational movements of the three part connection are linked to movement and force sensors, for example by means of internal wiring systems, which is well known to the man skilled in the art. Also the rotational forces and movement may be measured with sensors, which are well known and commercially available.

The signals of the sensors are monitored and stored in a register for immediate or later evaluation. During the diagnoses of the movement of the patient's head, professional personnel, as well as the patient, may use a display functionally connected with the sensors for controlling the parameters for the movement and the forces of the head unit 2. Preferably, the signals of the sensors are monitored in connection with a computer system which allows processing of the data during the training/evaluation session or for off-line evaluation after the session.

This data processing may be used to evaluate the movement and the corresponding forces in accordance with predetermined algorithms for thorough analysis. The calculated results may be displayed graphically, for example as curves or two or three dimensional models that eases the understanding of deviations from a normal case and also allows easy comparison with other patients.

In the following, an example of a monitoring and operating system with suitable interface will be described. The features of the apparatus according to the invention, which are described in this connection, are to be understood to be usable with other monitoring, operating and interface systems as well.

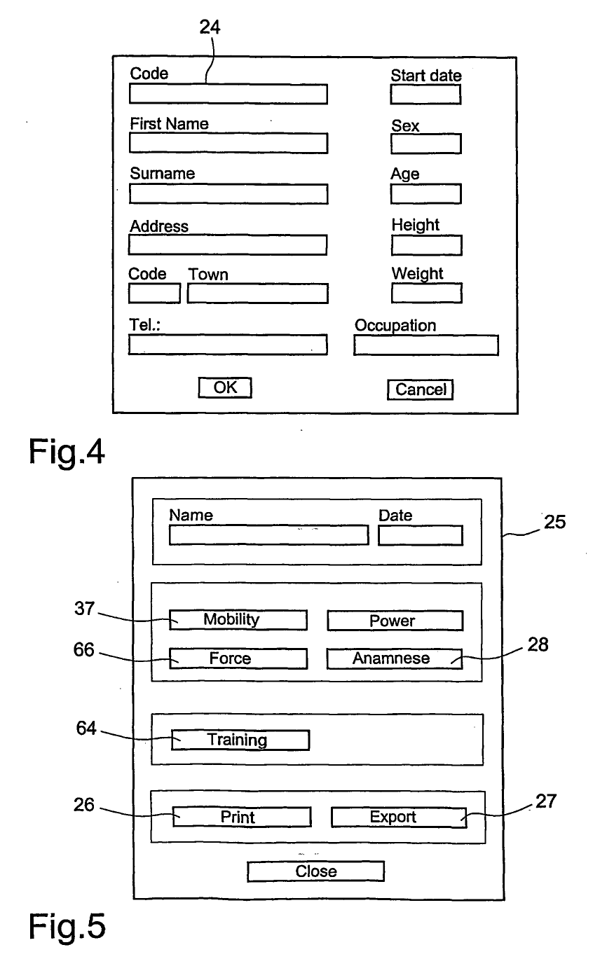

The interface system of the apparatus according to the invention has a first menu 22, as shown in FIG. 4, for insertion of client data 23 which may be the name, address and telephone number, sex, age, height, weight and occupation of the client and eventually an identification code 24. This menu and the following menus may appear in principle as well-known from commercially available operating systems, for example Microsoft Windows®, such that the user experiences the program as familiar already from an early stage.

In a second menu 25 showing the name of the client and the actual date, as illustrated in FIG. 5, a number of functions may be chosen. For example, client data may be printed 26 or exported 27 to another computer program.

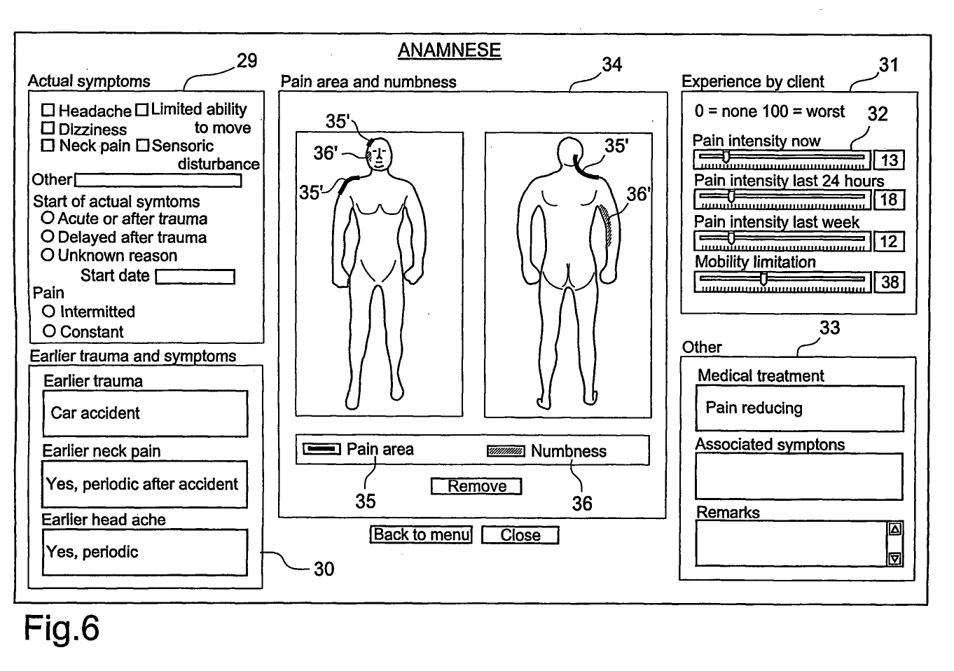

The user, for example the supervising personnel or the patient itself, may chose to review the anamnesis 28 of the patient. In this case, a new menu appears as illustrated in FIG. 6. Symptoms 29 as constant or intermitted pain, dizziness, or limited mobility may be indicated in the diagram. Also shown may be historical data 30. Data 31 for the patient's own experience of pain or mobility limitation can be inserted and illustrated graphically by bars on a percentage scale 32 as well. Further records 33 may indicate eventual medication and other relevant data. On the graph 34, on which a stylistic person is shown, pain areas 35 or numbness 36 may be drawn, for example by a computer mouse action, and indicated with dark 35′ and 36′ on the graph 34.

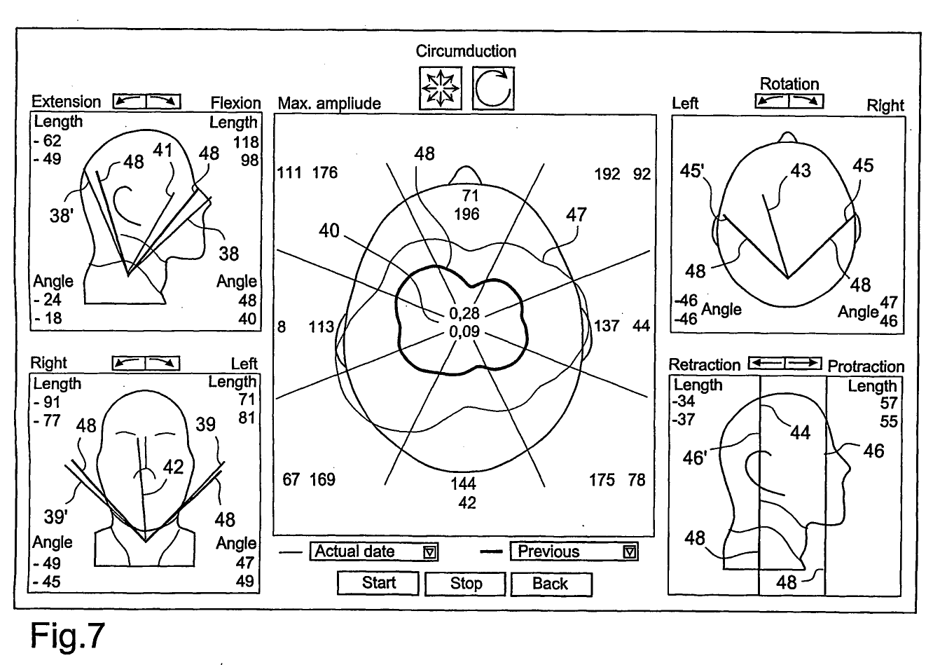

With reference to FIG. 5, activation of the mobility function 37 is linked to a mobility menu as shown in FIG. 7. The movement of the head of the patient is registered automatically and indicated by lines with different thickness 38, 38′, 39, 39′, 41, 42, 43, 44, 45, 45′, 46, 46′ in the different diagrams with units of length and angle. From measured data, a mobility model is computed and shown graphically. For example, the bending of the head in the forward direction, and in the two transversal direction is indicated with lines 38, 38′ and 39, 39′, 45, 45′ in diagrams, respectively. Also translational movements are indicated by respective lines 46, 46′ in a diagram. The patient may in addition move the head along a curve with maximum bending of the neck. The complete mobility may be indicated by a curve 47 in the central graph. The area enclosed by this curve 47 is indicative of the mobility of the patient. Actually measured data may be compared to a set of earlier data 48 in each of the diagrams or data from a comparable patient.

Those curves or two or three dimensional models eases the understanding of deviations from a normal case and allows easy comparison with other patients. A possible standard in this respect may be the above described area that the head movement of the patient may span in space linked with the corresponding forces, eventually in a three dimensional graphics model. The form and size of this area reveals the flexibility of the cervical region and is a simple but efficient way for comparison. Agreeing on such a standard internationally would result in a substantive data exchange across country borders. Such an area may be constructed from a number of vectors illustrating the movement in certain directions. Also, the patient may perform half circles or quarter circles which are combined to an area for illustration.

Other data, however not shown in the drawings, may be registered and illustrated as well, as for example myofeedback data from sensors placed on the patient. This way, the electrical potential from the muscles may be measured during activity and compared to other registered data.

The equilibrium position, that is to say the position of the head unit 2, when no force is acting on it, can be chosen by the patient. Thus, before diagnostics and training is performed, the head unit 2 may be positioned in accordance with the most natural placement of the head as experienced by the patient. This way, the position experienced as natural for the patient, sitting or standing upright, can be compared with the position that should be the natural position for a normal and healthy person.

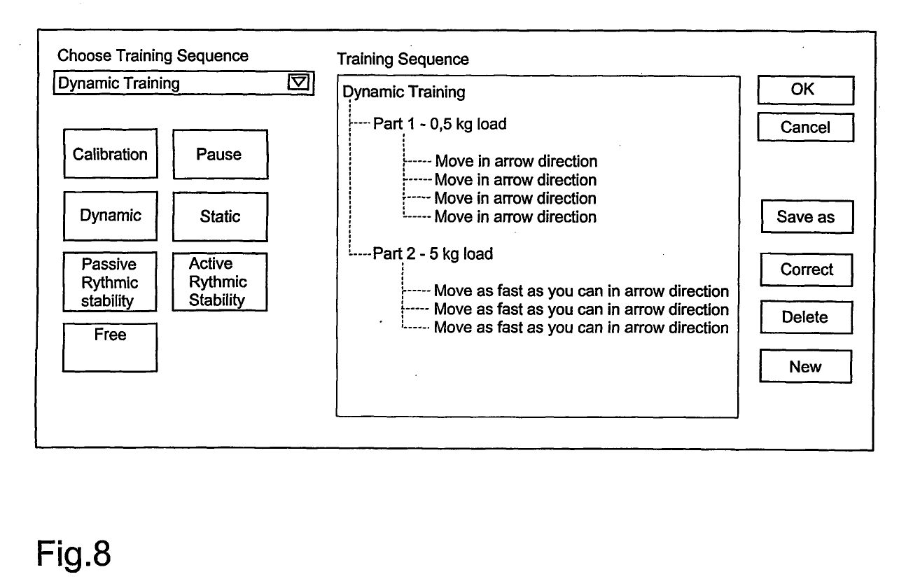

The training session of a patient may be assisted by a trainer or therapist, but may also be performed by the patient on his/hers own motion, for example by using a remote control. In this case, the training session may be performed in agreement with predetermined programs that the user may chose among a variety of programs as illustrated in FIG. 8. It is also possible to program the apparatus of the invention beforehand for different training sessions. Thus, the trainer may program a number of training sessions for the patient that the patient performs in accordance to a pre-chosen time schedule. This would reduce the necessary labor of experts and in addition give the patient more freedom to chose a convenient training time.

The patient may also program the training session himself. In this case however, security algorithms prevent the user to program the apparatus to training sessions that may be unsuitable or even dangerous for the patient. For example, maximum amplitudes and forces for head movements from the equilibrium position may be integrated in the training program.

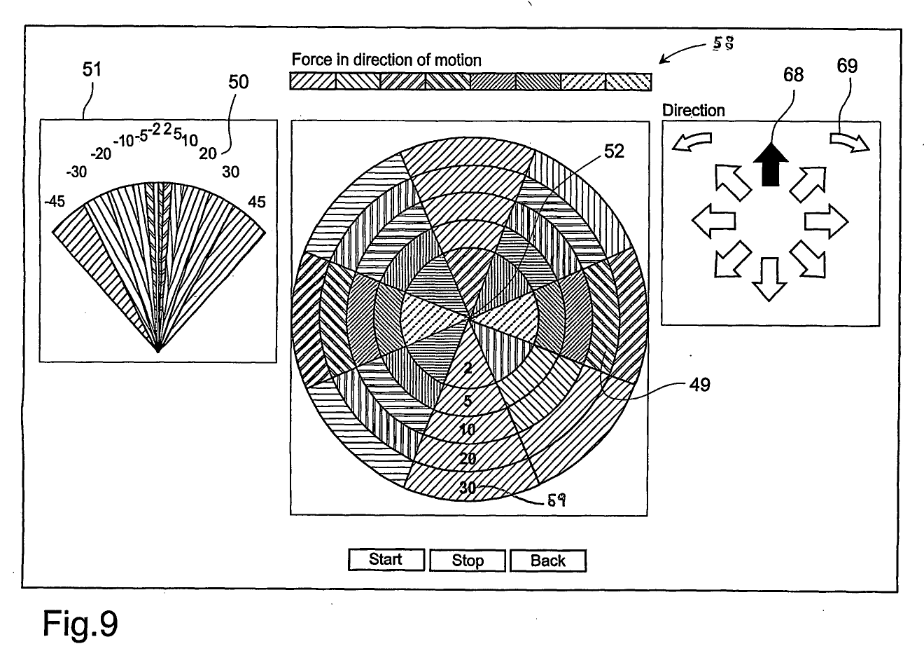

The training session of the patient, initialized with an appropriate command 64 as illustrated in FIG. 5, may as illustrated in FIG. 9 be configured to let the patient follow a direction of movement indicated by arrows 68 for the linear movement or by arrows 69 for turning movements. In relation to different directions, different forces may be exerted on the head unit, which may be illustrated in the central graph of FIG. 9, by for example a certain hatch 49 corresponding to a certain force interval according to a certain scheme 48. The shown hatches are only chosen for illustrating reasons, whereas in practice, shadings or colors would be applied for easier recognition. In the central graph, the strengths of the forces are shown in dependence of the rotational angle and the bending angle that is represented with numbers 59. The rotational force may be illustrated with different shadings or colors in dependence of the rotational angle 50 in the left graph 51.

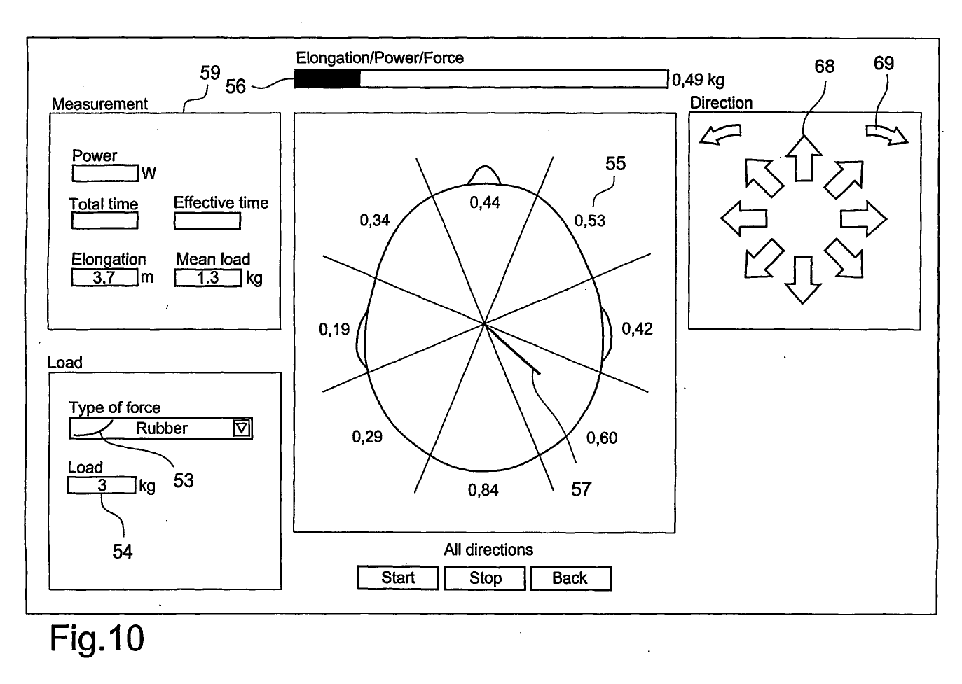

The dependence of the strength of the force in dependence of the distance from the equilibrium position 52 may be chosen in accordance with preprogrammed models. For example, the force may be applied as simulating a rubber band, which is illustrated in FIG. 10 lower left menu. The force increases non-linearly with distance from the equilibrium, which is indicated as a bend curve 53.

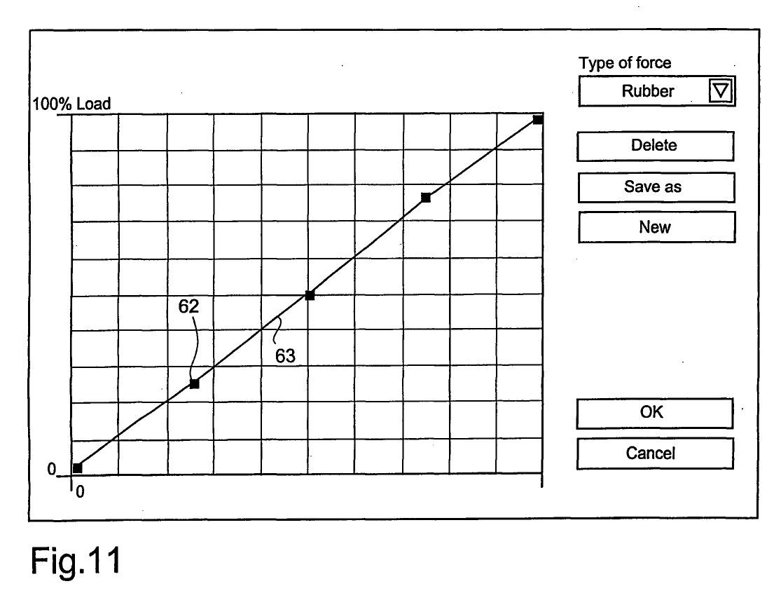

This bend curve may be changed in a very simple matter by using an interactive menu, which is shown in FIG. 11. The square dots 62 on the graph are so called handles that can be moved, for example by a computer mouse action. Moving these handles 62, to which the curve 63 stays attached, results in a modification of the curve 63.

With reference to FIG. 10, the maximum force 54 may be chosen as well with different directions as indicated by arrows 68 for bending movements. The force related elongation, the force, or the power may be represented by numbers 55. Also the actual elongation, force or power may be illustrated on a bar 56 together with the actually acting elongation, force or power as a number 55 or a colored line 57.

Results from the training session may be indicated graphically in the upper left menu 59 showing, for example, the elapsed time, the trained distance, the average force, power and eventually further related data.

The force that is acting on the head unit 2 may be dependent on the movement of the head, for example dependent on the speed or the distance from the equilibrium position. Alternatively, the force acting on the head may be dependent on a static position such that force is applied to the head unit 2 in different directions until the patient starts to move the head unit 2. The exercise for the patient is to resist the force and to try to keep the head in a fixed position, which can be different from the equilibrium position.

Furthermore, the functioning of the apparatus may be stopped by the patient by a switch in reach of the patient at all times. This switch may be part of a remote control that the patient may use to change the force and direction and/or the predetermined program

Also, the data processing system functions interactively with the user. For example, the user, that may be the trainer or the patient, may indicate on the graphic curves the positions and forces, where the patient feels pain during the training session. This may be combined with the graph as illustrated on FIG. 6.

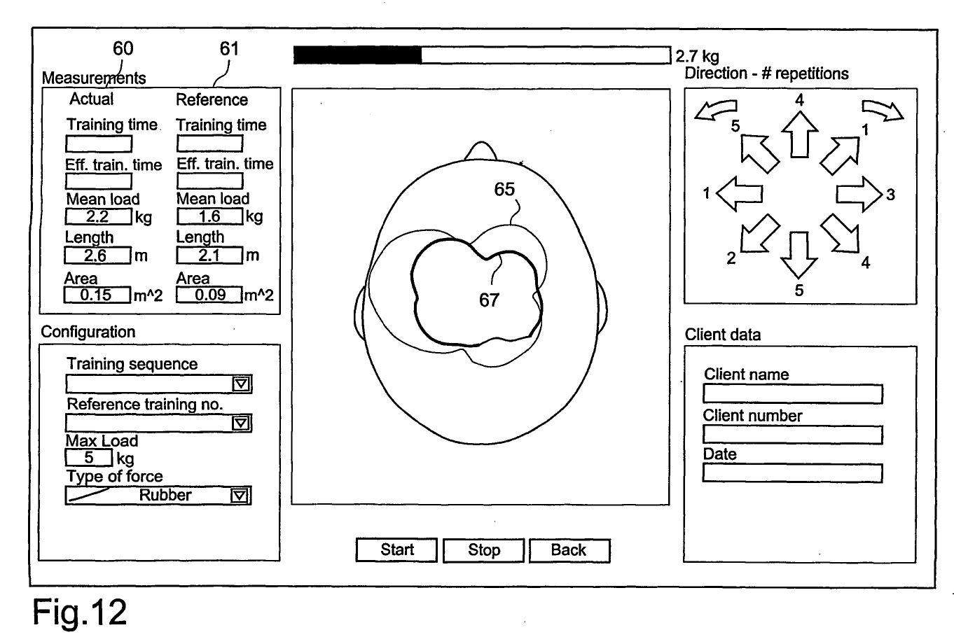

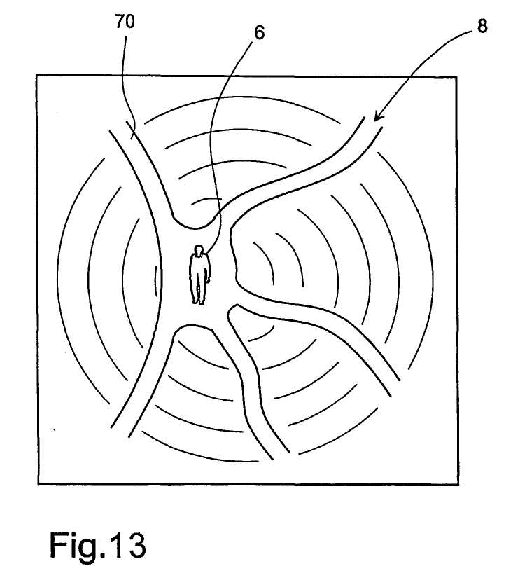

In order to compare actual results with earlier or reference data, for example from a different patient with similar symptoms, data 60 for the actual training session may be shown in comparison with theses reference data 61, as illustrated in FIG. 12. The force data menu, initiated by a command 66 from the menu in FIG. 5, also graphically illustrates 65 the force that the patient exerts on the head unit 2 during the movements of his head. These graphically displayed data 65 can easily be compared to reference data 67 or data from an earlier training session.

Having monitored and digitally stored the data for the movements in connection with a training session, it is also possible from the relation between the data of the bending of the patients head and the protraction and retraction data, for example as illustrated in FIG. 7, to calculate, which part of the cervical region is flexible or stiff.

The processed data from different training and diagnosing session according to the invention allows substantive organization and comparison of the recovery progress for different patients in dependence of different training principles, revealing optimal conditions for fast recovery.

In FIG. 13, a monitor image is shown illustrating an interactive user interface with an indicator 6 on a background monitor image. The indicator 6 is functionally connected to the movement sensor of the apparatus and configured to move on the background image in relation to the movement of the head unit 2. The background image shows a path system 8 motivating the patient to move the head unit such that the indicator 6 follows the paths 70 in the path system 8. The training session appears to the patient as playing a game and deflects the attention of the patient from eventual pain experience because the play requires attention from the user. The user may therefore achieve better results with larger amplitudes of movement despite the related pain.

1. Apparatus for evaluating segmentary immobility and the ability for muscle co-ordination of the cervical region of a patient, said apparatus comprising
a head unit for receiving the head of said patient, wherein said head unit is connected to a support frame,
a flexible, multi-axial rotational connection between said head unit and said device such that said head unit is able to follow said head of said patient with arbitrary rotational movement,
at least one movement sensor to register the movement of said head unit relatively to said support device,
a monitoring system functionally connected to said at least one movement sensor, wherein said monitoring system is configured to monitor and store parameters of the movement of said head in said head unit,
characterised in that said apparatus also comprises
a flexible, multi-axial translational connection between said head unit and said device such that said head unit is able to follow said head of said patient during both arbitrary lateral and rotational head motion with arbitrary head motion amplitude, and
an analyzing system functionally connected to said monitoring system for analyzing the segmentary mobility of the cervical region of said patient.

2. Apparatus according to claim 1, wherein said apparatus comprises at least one force sensor for measuring the force exerted on said head unit, said force sensor optionally being functionally connected to said monitoring system to monitor and store parameters of the force exerted on said head unit.

3. Apparatus according to claim 1, wherein said apparatus comprises at least one force element, said at least one force element being operational to exert force on said head unit.

4. Apparatus according to claim 3, wherein said at least one force sensor and said at least one force element are functionally connected and configured in co-operation to counteract the gravity of said head unit such that said head unit appears weightless.

5. Apparatus according to claim 4, wherein said at least one force sensor and said at least one force elements are configured in co-operation to counteract the inertia of said head unit during movement such that said head unit appears weightless during motion.

6. Apparatus according to claim 3, wherein said force element is operational to exert force in a direction counteracting the movement of said head unit.

7. Apparatus according to claim 3, wherein said force is at least one from the group consisting of
constant in magnitude along a path during the movement of the head unit,
constant in magnitude but independent of the direction of the movement of the head unit,
decreasing along a path during the movement of the head,
increasing along a path during the movement of the head,
dependent on the speed of the movement of the head unit,
dependent on the speed of the movement of the head unit,
dependent on the speed of the movement of the head unit in a way such as to imitate movement under water.

8. Apparatus according to claim 1, wherein said monitoring system comprises a computer system with display unit for processing and displaying said parameters related to said movement of said head unit, preferably in graphical form.

9. Apparatus according to claim 8, wherein said parameters include at least one from the group consisting of
the actual position of the head unit,
the speed of the head unit,
the velocity of the head unit,
the acceleration,
the direction of acceleration,
the natural equilibrium position as felt by said patient,
the natural equilibrium position as expected and indicated by a therapist,
maximum translational, bending and rotational amplitudes for said head unit,
head unit positions where said patient indicates pain,
forces exerted on said head unit,
the area of possible motion of the head of said patient in said head unit.

10. Apparatus according to claim 1, wherein said apparatus comprises a monitor visible by said patient, said monitor illustrating an interactive user interface with an indicator on a background image, said indicator being functionally connected to said movement sensor and being configured to move on said background image in relation to said movement of said head unit.

11. Apparatus according to claim 10, wherein said background image shows a path system motivating said patient to move said head unit such that said indicator follows the paths in said path system, said path system preferably being specially designed according to the cervical condition and/or cervical training of said patient.

12. Apparatus according to claim 1, wherein said apparatus is configured to be applicable for
passive rhythmic stabilization, wherein said head unit is stationary at a prefixed position until the force exerted on said head unit by said patient is higher than a preset level, after which said head unit is configured to reluctantly follow the direction of the exerted force, or
active rhythmic stabilization, wherein said head unit exerts force on said head of said patient as long as said head unit is not moved, where the level of said force increases until a preset value after which said force decreases and builds up in a new direction.
